(19) United States
(12) Patent Application Publication
(10) Pub. No.: US 2010/0031039 A1
(43) Pub. Date: Feb. 4, 2010

(54) METHOD AND APPARATUS FOR DATA PROTECTION SYSTEM USING GEOMETRY OF FRACTALS OR OTHER CHAOTIC SYSTEMS

(76) Inventors: Mathieu Ciet, Paris (FR); Augustin J. Farrugia, Cupertino, CA (US); Jean-Francois Riendeau, Santa Clara, CA (US)

Correspondence Address: APPLE C/O MOFO PALO ALTO, 755 PAGE MILL ROAD, PALO ALTO, CA, 94304-1018, US

(21) Appl. No.: 12/031,525

(22) Filed: Feb. 14, 2008

(51) Int. Cl. H04L 9/00

(52) U.S. Cl. 713/168; 726/26

(57) ABSTRACT

In computer based data security systems which involve entity authenticating or document time stamping or other cases where data is to be derived from a previous state, the necessary linking values are calculated using recursive chaos based equations such as the type used in fractal theory (the Mandelbrot set) or the Lorentz attractor or other similar approaches. In each case a value in each step is calculated using these equations so that each authentication or timestamp or other data derivation is linked to the previous one in a chaotic way. This makes it impossible to calculate any one value in the link series without having the previous value, due to the chaos aspect thereby enhancing security.

### FIELD OF THE INVENTION

This invention relates to data protection and data security and more specifically to data protection and security systems usable over a period of time by different users.

### BACKGROUND

The data security field is well known and is especially important for security relating to computer type data which is typically transmitted, for instance, by e-mail or via electronic means including Internet downloading and streaming of audio, video and other data files. It also pertains to, for instance, transmission of secure messages on other electronic channels such as in the military or government context and in the context of financial transactions.

A well known problem in the field of communications security is the problem of authenticating one entity to another. There are two known ways to provide authentication, which is a verification of a message or file being genuine (from the identified sender). Authentication is typically encountered when a user logs on to a host computer or any other type of computer or communication system. The question is, how does the host know who the user is. In other words, how does a host know that the user is not trying to falsify the identity of another person. This is often accomplished with passwords. However, a more sophisticated approach does not require use of passwords which of course must be stored at the host, and if hacked into the password system is rendered useless.

Hence authentication is used. In one case, for instance, the host stores one-way function of all the passwords. The user transmits the password to the host. The host performs the one-way function on the password. (One-way functions are well-known in the cryptographic field.) The host compares the result of the one-way function to the value it previously stored, which is a table of the one-way functions of all the possible passwords. Here since the host no longer stores a table of all valid passwords, the threat of a hacker breaking into the host and stealing the password list is eliminated. The hacker's access to the host's list of passwords operated on by the one-way function is also not useful to the hacker because the one-way function by its nature cannot be reversed to recover the actual passwords.

In another type of authentication the first entity which is, for instance, the host generates a random challenge which the second entity which is the recipient (user) encrypts upon receipt with a shared cryptographic key and transmits it back to the host. The second entity is authenticated if the decryption of the return value equals the challenge.

This authentication can also be done using public key cryptography which is also well known. Here the public key of the second entity is available to the first entity who sends a challenge to the second entity that returns a result of the one-way function computation using the secret key of the second entity. The first entity authenticates the second entity using the public key of the second entity. This involves the elimination of shared keys. Of course, public key cryptography is relatively more time consuming and/or requires more storage than symmetric (private key) cryptography.

Related to authentication is time stamping of documents which is a way of authenticating documents rather than entities. This refers to electronic documents (files) as used in computer systems.

Time stamping fulfills the need of individuals wanting to certify that a document actually existed on a certain date. Since digital documents are readily altered, unlike paper documents, this is relatively complex in the data security field. In other words, it is impossible to examine a digital document for signs of tampering. This also goes for any date stamp on a document such as data or other computer file.

Hence computer based time stamping typically involves the first entity transmitting a copy of a document to a trusted entity. The trusted entity records the date and time it receives the document and retains a copy of the document for safekeeping. This provides authentication of the document later, but has the problems of first, eliminating any privacy since the trusted entity must have a copy of the original document and the original document must be transmitted to the trusted entity allowing interception. Also, the trusted entity ends up with an extremely large storage of time stamped documents, and transmission of long documents to the trusted entity is expensive and time consuming. It also relies on the trustworthiness of the trusted entity time stamping service, which may be in doubt.

It is well known to overcome these problems using one-way (“hash”) functions and digital signatures. Hash functions are well known. A hash function is essentially a numerical digest of a file typically using a one-way function so that while it is easy to compute the hash value of a document it is impossible to produce the document from the hash function. Digital signatures are also well known as a means of identifying individuals. Time stamping is accomplished whereby by the originator of the document produces a one-way hash value of the document. The hash value is transmitted to the trusted entity. The trusted entity appends the date and time it received the hash value to the hash itself and digitally signs the result and then transmits the signed hash value with the timestamp back to the originator. Thus there is no need to reveal the contents of the document to the trusted entity. The trusted entity only receives the hash value. The trusted entity also no longer has to store copies of the document or even the hash value itself. Also, the recipient upon receiving the signed hash value can verify that it is accurate and thus eliminate any possibility of transmission errors.

A remaining problem with time stamping is that the originator and time stamping service may collude to produce any timestamp they want. This problem however has been solved by using a linking protocol. This is done by linking the timestamp on a particular document with time stamps previously generated by the same trusted entity. These other time stamps will mostly likely be generated for other document originators. Since the order that the trusted entity receives the different documents for time stamps is not known in advance to anyone, it is clear that the timestamp of any one document must have occurred after the previous timestamp and before the subsequent timestamp, which typically is issued to others. This provides a place in time for each time stamp, in other words, linking. This is also referred to as a “tree” of hash values whereby some nodes on the tree are published to the public and the timestamp of a document is given by a set of hash values and other information on each node to access the document in the tree of hashes. This presents the problem of time linking of the timestamps.

The linking problem is also present in authorization since linking may be needed to link various authorizations. Thus it may be needed to link one authentication to the previous ones in sequence. This means that the shared cryptographic key used for authorization changes along time in a given way. Thus, it may be necessary for each key to be linked to the successful previous authentication, for instance by recording the previous authentication where each authentication is a function of the previous one.

Thus a general problem in the data security area is time linking, and it is recognized that more secure and computationally efficient time linking processes are needed.

### SUMMARY

In accordance with this invention, a linking process is provided suitable for time stamping, authentication or other types of data derivation where there is a time oriented linking of a succession of values in a secure manner. In accordance with the invention, linking is provided using recursive equations for instance of the type used in fractal theory known as the Mandelbrot set. Other types of recursive equation approaches may also be used such as the well known Lorentz attractor. Equivalents of these are also known. In any case, each of these mathematical concepts provide a type of chaotic flow which for the present purposes of linking may be regarded as time oriented (although time is not a necessary dimension.) These recursive functions typically are variously available in one, two, or three-dimensional versions.

Therefore, in accordance with the invention these type of recursive functions which express a chaotic system are used for purposes of linking. First one sets an initial condition typically for one or two variables x and/or y (depending on whether a one- or two-dimensional recursive function is used). Then one applies the recursive function to the initial values of variables x and y to result in the successor values for x and y which are linked to the initial condition values. Recursively then the equations are applied to each successive value to generate a linked set of values for each of variables x and/or y. Note that each value in the linked sequence of values can only be computed if all the previous values have previously been computed using the same initial conditions or if the previous value has been supplied by another entity.

This technique is applied to the authentication situation whereby each of the two entities in order to authenticate one another applies the same recursive function so that each authentication is linked to the previous one.

This is also used for time stamping in constructing the links of one hash value to the previous one in the tree sequence.

In addition to authentication and time stamping, other types of data derivations can be carried out with this approach where a linked series of values is required and it is important that each value only be computed after computation (or receipt) of the previous value. As can be seen, this is generally useful for security in communications.

### BRIEF DESCRIPTION OF THE DRAWINGS

FIG. 1 shows diagrammatically an image of a Mandelbrot set (prior art).

FIG. 2 shows diagrammatically a plot of a trajectory of the Lorentz attractor system (prior art).

FIG. 3 shows a tree of hash values (prior art).

FIG. 4 shows both a flow chart and apparatus for carrying out the present process and embodying the present apparatus.

### DETAILED DESCRIPTION

By way of further background, the Mandelbrot set M is a set of points in the complex plane that forms a fractal. Mathematically the Mandelbrot set is defined as a set of complex c-values for which the orbit of zero under iteration of the complex quadratic polynomial x²+c remains bounded. The Mandelbrot set is a complicated structure arising from a simple definition. FIG. 1 shows a two-dimensional image of a Mandelbrot set M showing the characteristic fractal appearance. The black points are members of the set. Mandelbrot sets are readily computed by use of computer programs since they are simple quadratics. The Mandelbrot set can be expressed in a single dimension version as a single time-related scalar or in a two-dimensional version. Other dimensional versions are also available. The single dimension version of the Mandelbrot set is expressed by the equation yₙ₊₁=2yₙ[(yₙ−b]²/4y²ₙ₋₁−y²ₙ₋₁+a]+b. The initial values are y₋₁=0 and y₀=b.

There is also the two-dimensional version in variables x and y which would be as represented in FIG. 1 whereby xₙ₊₁=x²ₙ−y²ₙ+a; and yₙ₊₁=2xₙyₙ+b where initially x₀=y₀=0, or x₀=a and y₀=b. In accordance with this disclosure either the single dimensional approach or the two-dimensional approach may be used. The Mandelbrot set was developed by the mathematician Benoit Mandelbrot in 1980.

For simplicity purposes, instead of considering these functions defined over all real numbers, they may be considered modulo a prime number p. Typically p=3(mod4), meaning that the remainder of p divided by 4 is equal to 3. In other notation, p=3(mod4) is equivalent to ∃R∈ N [symbol] :p=3+R*4. In practice one often uses the value p=2¹²⁸−237.

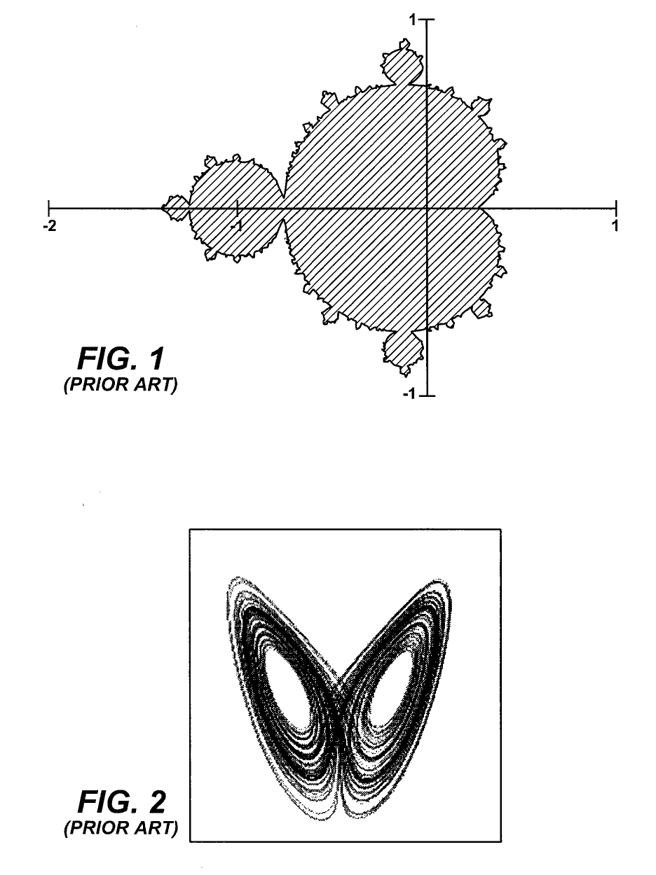

The Lorentz attractor depicted in FIG. 2 is a three-dimensional structure corresponding to the long term behavior for chaotic flow and noted for its typical butterfly shape. This is somewhat different from the Mandelbrot type shape and is not a fractal but has similar characteristics of embodying a chaotic system. This system is well known as introduced by Edward Lorentz in 1963.

The Lorentz attractor is governed by three equations which are derivatives of three variables with respect to a parameter t of variable x, y and z with three constants. The Lorentz attractor equations are:

$$\frac{d x}{d t} = σ ( y - x )$$

$$\frac{d y}{d t} = x ( ρ - 2 ) - y$$

$$\frac{d z}{d t} = xy - β z$$

where σ, and ρ are constants and β varies.

The following description uses as an example the recursive equations of the Mandelbrot set but this is not limiting and instead the Lorentz attractor equations or other types of chaotic systems may be used, so long as they provide recursive computation of values with a dynamic chaos aspect.

In the authentication application of the present linking process, the two entities C and D share an initial status defined by b and an intermediate state yₙ. In order to perform an authentication, party C sends to party D a timing challenge t. D, upon receipt of the timing challenge t, computes the value yₙ₊ₜ and, if necessary, xₙ₊ₜ in the two-dimensional Mandelbrot set version and transmits these value(s) to party C who is able to perform the same computation on his side. If at the C side the result of his computation matches what he receives from D, this is regarded as a match, or correct authentication. Then C and D both update yₙ (and xₙ, if needed) into yₙ₊ₜ (and xₙ₊ₜ). This last value yₙ₊ₜ and/or xₙ₊ₜ is used for the next authentication. Thus each authentication is linked to the previous one and can only be derived using the previous one.

In one application this linking approach is used to derive the authentication cryptographic key used in an authentication system using, for instance, symmetric cryptography such as AES. AES is a well known symmetric (private key) cipher, and is only exemplary here. Other such ciphers are DES, or triple DES. This means that the shared AES (or other cipher) decryption/encryption key k is changed with the previous function to the next authentication using the recursive equation. Note that the key update can only be done after a particular number of authentications, and each authentication must be carried out in order. The authentication can also employ private key cryptography. As described above, such as RSA.

The two dimensional x,y values are used for linking in several ways. One example is to define a 64-bit plane p in (x,y) and concatenate xₙ₊ₜ, yₙ₊ₜ for p. Another example involves expanding a key k into a function of two variables (the two dimensions).

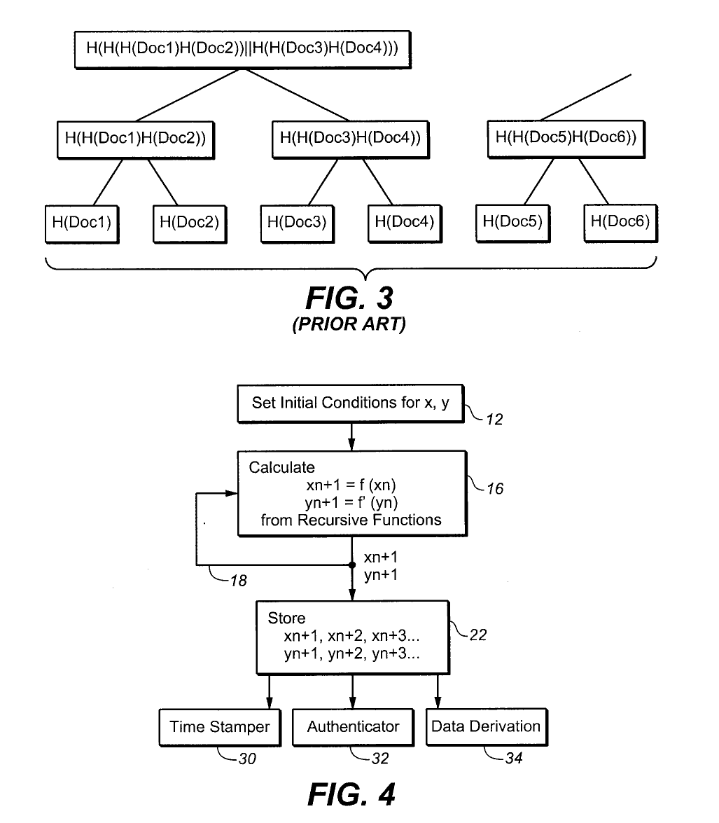

In time stamping, as explained above the goal is to fix a date associated with a particular electronic document. In the case of hard copy or paper documents, this is typically done by physically signing a document in the presence, for instance, of a notary public. In the digital world this must be done by creating links between documents, the links typically being related as a sequence generated in time. This means that the linking process must indicate whether a document was time stamped before or after any other document that has been time stamped using the time stamping scheme. As pointed out above it is well known to do this using a tree of hash functions as shown in FIG. 3. Along the bottom row there are series of documents, Doc 1, Doc 2, Doc 3, etc. For each a hash function H is computed. As pointed out above, hash functions are well known in the data security field. These are typically what are referred to as one-way hash functions. They are also called compression functions, contraction functions, message digest, fingerprint, cryptographic checks, message integrity check and manipulation detection code. Hash functions are well known in the computer field. A hash function is a mathematical or other function that takes a variable length input string and converts it to a fixed length (generally of shorter length) output string referred to as the hash value. Examples of hash functions are SHA-1, SHA-2, Snefru, N-Hash, MD4, MD5, and MD2.

The goal is to provide what is referred to as a fingerprint of the original document which is a value that indicates whether a particular document is likely to be the same as another document. In other words, is a document genuine? One-way hash functions generally are designed to work in one direction so it is easy to compute a hash value from the original document but is very hard to generate the original document that hashes to a particular value. With a “strong” one-way hash function this reconstruction of the document is indeed practically impossible. In this context “strong” means that given a hash value H of data F, it is very hard to construct a second data F′ that has hash value H. The hash function itself is typically public. Security resides in the one-way nature of the function so that the output is not dependent on the input in any discernible way. A message authentication code, also known as a data authentication code, is a one-way hash function with the addition of a secret key. It is used the same way as a hash function except that only someone with the key can verify the hash value. A message authentication code (MAC) can be created out of the hash function or a block encryption algorithm.

In the hash value timestamp tree depicted in FIG. 3, the second row from the bottom computes a hash function of a concatenation of the two previous hash function values. As seen this is done 2×2, but it could be done otherwise. In the top row a hash function is created of the concatenation of each of the two hash functions from the lower two rows. This structure is referred to as the tree of hashes and thus reduces the needed value to a single hash value. In the conventional time stamping approach, the values of some particular nodes (hash values) are published. The timestamp of a particular document is given by a set of hash values and information relating to its node in order to access the document in the tree of hash values as shown in FIG. 3. For instance, at one time a timestamp hash value was published weekly in the New York Times.

The document originator sends the trusted entity his name A (of the originator) and the hash value Hₙ of the originator's document that the originator A wishes to be time stamped. The trusted entity transmits back to the originator A the value Tₙ=Sₖ(n,A,Hₙ,Tₙ,Hₙ₋₁,Iₙ₋₁,Hₙ₋₁,Tₙ₋₁,Lₙ) where Lₙ consists of the following hash linking information: Lₙ=H(Iₙ₋₁,Hₙ₋₁,Tₙ₋₁,Lₙ₋₁). I refers to the identity of the originator of each document I.

Sₖ indicates that the message is signed with the trusted entity's public cryptographic key k. (This uses public key cryptography.) The name of the originator A identifies that person as the originator of the time stamping request. Subscript n indicates a sequence of the request. In other words this is the nth timestamp that this particular trusted entity has issued. The parameter Tₙ is the time itself. The additional information provided is the identification, original hash value, time, and hash timestamp of the previous document time stamped by that trusted entity. After the trusted entity time stamps the next document, it transmits back to the originator of the earlier document the identification of the originator of that document which is Iₙ₊₁. The upper part of the “tree” of documents is published so that anyone can verify the document with the available information.

Thus when it is desired to later use the timestamp to verify a document's time, the challenger of the timestamp of a document contacts the trusted entity, or originators of the previous and following documents who are individuals Iₙ₋₁ and Iₙ₊₁. The trusted entity provides to A all the hash values from this document to last hash value which is published. If their documents are called into question the individuals in turn can contact the trusted entity or originators Iₙ₋₂ and Iₙ₊₂, etc. Each person can thereby show that their document was time stamped after the one that came before and before the one that came after. This largely prevents collusion between any one originator and any one timestamp provider.

It is also possible to do away with the trusted entity. This approach uses the hash value Hₙ as an input value. The originator of the first document generates a string of random values using a cryptographically secure pseudo or random number generator. Each of these values is interpreted as the identification of another person. The hash value Hₙ is transmitted to each of these people. Each of these people attaches a date and time to the hash Hₙ, signs the result with his digital signature and transmits it back to the originator. The originator then collects and stores all the signatures as the time stamp. The only way then for the originator to provide a false timestamp would be for all the other people to cooperate. Since these are chosen in random that would be difficult.

Thus the present linking system can be used in an otherwise conventional time stamping system as provided above using either the trusted entity or the random number generator approach since it gives a way to time link one step to the next. The hash value of the current document defines a constant b which is the initial condition b of e.g. the Mandelbrot set equations for the first document to be timestamped and also used in each recursive equation. The value of t or time is used as a parameter to update yₙ into yₙ₊ₜ. When needed for verification, the last value yₙ is published. Each timestamp of the document is constituted by its position in the hash tree and the consecutive yₙ value, node after node as described above. Thereby this provides an improvement over prior art time stamping schemes, because some of the hash values used to construct the tree can be avoided and replaced by the present recursive function as a tree of results of recursive equations. It is also possible to use the shared value or initialization to construct a proprietary timestamp as indicated above in the second example. Also, the present approach can be combined with a hash function to obtain an HMAC. Thus if yₒ is known, b can be updated as the next block of the document used as input of the HMAC.

Thus FIG. 4 shows in a combined flowchart and block diagram a computer implemented process in accordance with this invention. In the first block 12 a storage element (memory) is provided which stores the initial conditions for variable x and/or variable y depending on whether one is using a one or two-dimensional approach. Note that FIG. 4 uses the Mandelbrot notation, but this process is also suitable for use with the Lorentz attractor or other approaches (of course, the Lorentz attractor uses variables x, y, and z.). While this shows a two-dimensional Mandelbrot approach it is also suitable for the one-dimensional Mandelbrot approach where only variable y would be involved. Typically the initial condition for y₀ and x₀ is equal to the value b which is the hash value, or the initial values x₋₁=y₋₁=0.

Using these initial conditions and either the one or two-dimensional Mandelbrot set equation the value of xₙ₊₁ and y and/or yₙ₊₁ are calculated at 16 as respectively function of xₙ and yₙ as shown above. Then conventionally these values are fed back at 18 to calculate the next xₙ₊₁ and yₙ₊₁. The output values are also applied to a store or memory 22 which stores the sequence of values xₙ₊₁, xₙ₊₂, etc., and similarly for y if needed. These values are then provided to respectively a time stamper 30, authenticator 32 or data derivation tool 34 of the type described above for purposes of linking the successive values needed in these processes. For instance in the timestamp application as shown above with reference to FIG. 3, the hash value of each document defines the current value b and the value of t in this case is used as a parameter to update yₙ into yₙ₊₁. Thus each timestamp of a document is constituted by its position in the tree as indicated by the length value. In the authentication application, the values of xₙ, yₙ are used to generate the successive key values.

The present method and apparatus are typically embodied in a computer program conventionally coded in any suitable computer language such as C or C++ for execution by a computer or processor. The program would also carryout the remainder of authentication, time stamping or data derivation process. Coding such a program would be routine in light of this disclosure. Typically a compiled (object code) version of this program would be resident in a device or computer which is to carry out the authentication of time stamping or other data derivation function disclosed herein. Also, of course, a suitable user interface would be provided, as is routine in the field. Alternatively, the apparatus could be embodied in logic circuitry or firmware or any combinations of software and firmware and circuitry.

This description is illustrative but not limiting. Further modifications will be apparent to those skilled in the art in light of this disclosure and are intended to fall within the scope of the appended claims.

What is claimed:

1. A computer implemented method comprising the acts of:
setting an initial condition;
providing a recursive function expressing a chaotic system;
generating a series of link values, the first value being a function of the initial condition, and each successive value being the recursive function of the previous value; and
using the generated series of link values in a data protection process.

2. The method of claim 1, wherein the data protection process is one of a message authentication, a document timestamp, or a data derivation.

3. The method of claim 1, wherein the recursive function expresses the Mandelbrot set as a single time-delayed scalar.

4. The method of claim 1, wherein the recursive functions express the Mandelbrot set as a two-dimensional value.

5. The method of claim 1, wherein the recursive function expresses the Lorentz attractor.

6. The method of claim 2, wherein the message authentication includes:
transmitting a challenge relating to a current link value;
generating a next value of the series of links responsive to the challenge;
receiving the generated next value; and
matching the received next value, thereby to authenticate.

7. The method of claim 6, further comprising generating a message authentication code from each link value.

8. The method of claim 2, wherein the document timestamping includes:
providing a document;
computing a hash value of the document;
generating a next value of the series of links from the hash value; and
making available a last member of the series of links for comparison to earlier values in the series of links.

9. The method of claim 2, wherein the data derived is a set of cryptographic keys, each key being related to one of the link values.

10. A computer readable medium having computer readable code stored thereon for carrying out the method of claim 1.

11. A data protection system comprising:
a recursive function calculator expressing a chaotic system;
a store for an initial value, coupled to an input of the calculator;
an output of the recursive function calculator being coupled to a second input thereof;
and a store coupled to the output terminal, wherein the calculator outputs a series of link values, each being a function of the initial value, and wherein the link values are adapted for a data protection process.
